(19) United States
(12) Patent Application Publication
(10) Pub. No.: US 2009/0121692 A1
(43) Pub. Date: May 14, 2009

(54) Vibration-Reduction Fan Driving Circuit

(76) Inventor: Ching-Sheng Li, Hsinchu City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/044,308

(22) Filed: Mar. 7, 2008

(30) Foreign Application Priority Data
Nov. 8, 2007 (TW) 096142114

(51) Int. Cl. G05F 1/56

(52) U.S. Cl. 323/272; 323/282

(57) ABSTRACT

Avibration-reduction an driving circuit is applicable to a fan that operates according to a current signal sent thereto, and is characterized in a current buffer unit connected to a drive current supplied from a power source and having a relatively large magnitude of change in current. The current buffer unit divides the original drive current into multiple continuously changing drive currents that have a relatively small magnitude of change in current, so that electric current supplied to the fan is regulated and output fractionally to achieve the purpose of reducing the vibration of fan caused by a large magnitude of change in current.

### FIELD OF THE INVENTION

The present invention relates to a vibration-reduction fan driving circuit, and more particularly to a fan driving circuit that uses a current buffer unit to divide an original drive current having a relatively large magnitude of change in current into multiple continuously changing drive currents having a relatively small magnitude of change in current, so that electric current supplied to the fan is regulated and output fractionally to achieve the purpose of reducing the vibration of fan caused by a large magnitude of change in current.

### BACKGROUND OF THE INVENTION

FIG. 7 shows a conventional fan driving circuit, in which four switch elements A, C, D, F are sequentially turned on to control the current i for driving a fan L, as shown in FIG. 8. In FIG. 7, the fan L is represented by a magnetic induction coil thereof. The fan is vibrated when a magnitude of change in the current i occurs. To protect the fan against excessive vibration, many different techniques have been developed. For example, Taiwan Patent Number M313807 discloses an anti-vibration mount for heat-dissipating device for mounting between a heat-dissipating device and the housing of an electronic device. The anti-vibration mount includes an elastic member having a transverse through opening, and two fixing rods located at two opposite ends of the elastic member. Each of the two fixing rods has a protruded portion. When the two fixing rods are separately extended through mounting holes on the heat-dissipating device and the housing of the electronic device, the protruded portions on the fixing rods are abutted at respective bottoms on an inlet of the mounting holes, so that the heat-dissipating device is fixedly mounted to the housing. Further, Taiwan Patent Number M306461 entitled Anti-vibration Mechanism for Heat Dissipating Device and Taiwan Patent Number M269691 entitled Heat-dissipating Fan Mount with Vibration-reduction Structure also disclose other mechanical structures for protecting a fan against excessive vibration.

All the above-mentioned prior art require an additional vibration reducing device provided on the fan or even require modification of the overall configuration of the fan to largely increase the manufacturing cost of the fan. Besides, the additional vibration reducing device will occupy additional room in the extremely limited internal space of the housing of the electronic device. It is therefore desirable to overcome the problem of a vibrated fan in other improved ways.

### SUMMARY OF THE INVENTION

A primary object of the present invention is to provide a fan driving circuit that uses a current buffer unit to divide an original drive current having a relatively large magnitude of change in current into multiple continuously changing drive currents having a relatively small magnitude of change in current, so that electric current supplied to the fan is regulated and output fractionally to achieve the purpose of reducing the vibration of fan caused by a large magnitude of change in current.

To achieve the above and other objects, the fan driving circuit according to the present invention is applicable to a fan that operates according to a current signal sent thereto, and is characterized in a current buffer unit connected to a drive current supplied from a power source and having a relatively large magnitude of change in current. The current buffer unit divides the original drive current into multiple drive currents that change continuously and therefore have a relatively small magnitude of change in current, so that electric current supplied to the fan is regulated and output fractionally to achieve the purpose of reducing the vibration of fan caused by a large magnitude of change in current.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a circuit diagram of a vibration-reduction fan driving circuit according to a first preferred embodiment of the present invention;

FIG. 2 is a graph showing the circuit elements in the first preferred embodiment of the present invention in a turned-on state and the waveform of the current signal sent to the fan;

FIG. 3 shows the waveform of continuously changing drive currents according to a second preferred embodiment of the present invention;

FIG. 4 shows the waveform of continuously changing drive currents according to a third preferred embodiment of the present invention;

FIG. 5 shows the waveform of continuously changing drive currents according to a fourth preferred embodiment of the present invention;

FIG. 6 shows the waveform of continuously changing drive currents according to a fifth preferred embodiment of the present invention;

FIG. 7 is a circuit diagram of a conventional fan driving circuit; and

FIG. 8 is a graph showing the circuit elements in the conventional fan driving circuit in a turned-on state and the waveform of the current signal sent to the fan.

### DETAILED DESCRIPTION OF THE PREFERRED EMBODIMENTS

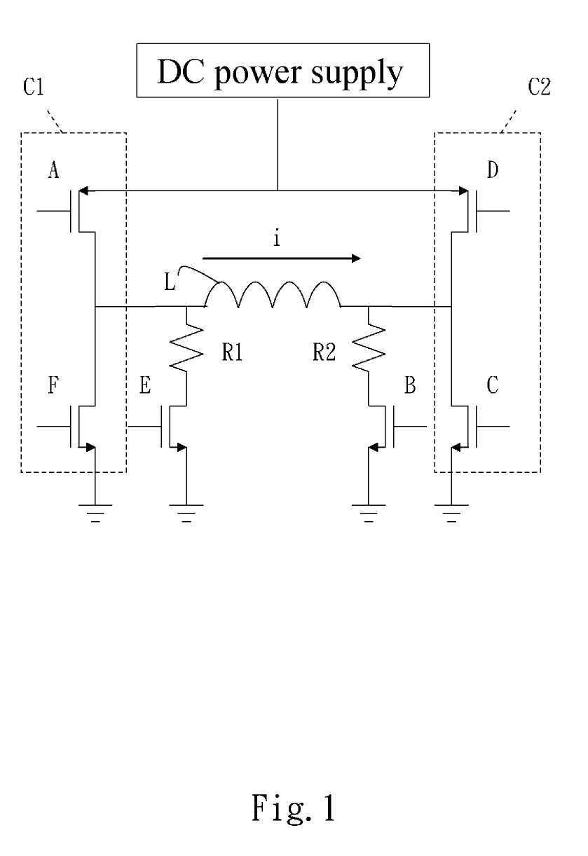

Please refer to FIG. 1 that is a schematic circuit diagram of a vibration-reduction fan driving circuit according to a first preferred embodiment of the present invention. The vibration-reduction fan driving circuit of the present invention maybe applied to fan L that operates according to an electric current signal sent thereto. In FIG. 1, the fan L is represented by a magnetic induction coil thereof.

The vibration-reduction fan driving circuit of the present invention is characterized in a current buffer unit connected to a drive current supplied from a power source and having a relatively large magnitude of change in current. The current buffer unit divides the original drive current into multiple continuously changing drive currents that have a relatively small magnitude of change in current, so that electric current supplied to the fan is regulated and output fractionally to achieve the purpose of reducing the vibration of fan caused by a large magnitude of change in current.

In the first preferred embodiment of the present invention, the vibration-reduction fan driving circuit includes a first and a second switch circuit C1, C2 that are connected in parallel. The two switch circuits C1, C2 respectively include a p-type metal semiconductor field-effect transistor (MSFET) A, D connected to a direct current (DC) power supply, and an n-type MSFET F, C connected to a ground. A first node N1 is formed between the p-type MSFET A and the n-type MSFET F in the first switch circuit C1; and a second node N2 is formed between the p-type MSFET D and the n-type MSFET C in the second switch circuit C2. And, the first and the second node N1, N2 serve as two inputs of the fan L.

In the first preferred embodiment of the present invention, the current buffer unit includes a first n-type MSFET E and a second n-type MSFET B, which are parallelly connected to each other and separately provided at two ends of the fan L. Wherein, the first n-type MSFET E is located between the first node N1 and the fan L, and parallelly connected to the first switch circuit C1; and the second n-type MSFET C is located between the second node N2 and the fan L, and parallelly connected to the second switch circuit C2.

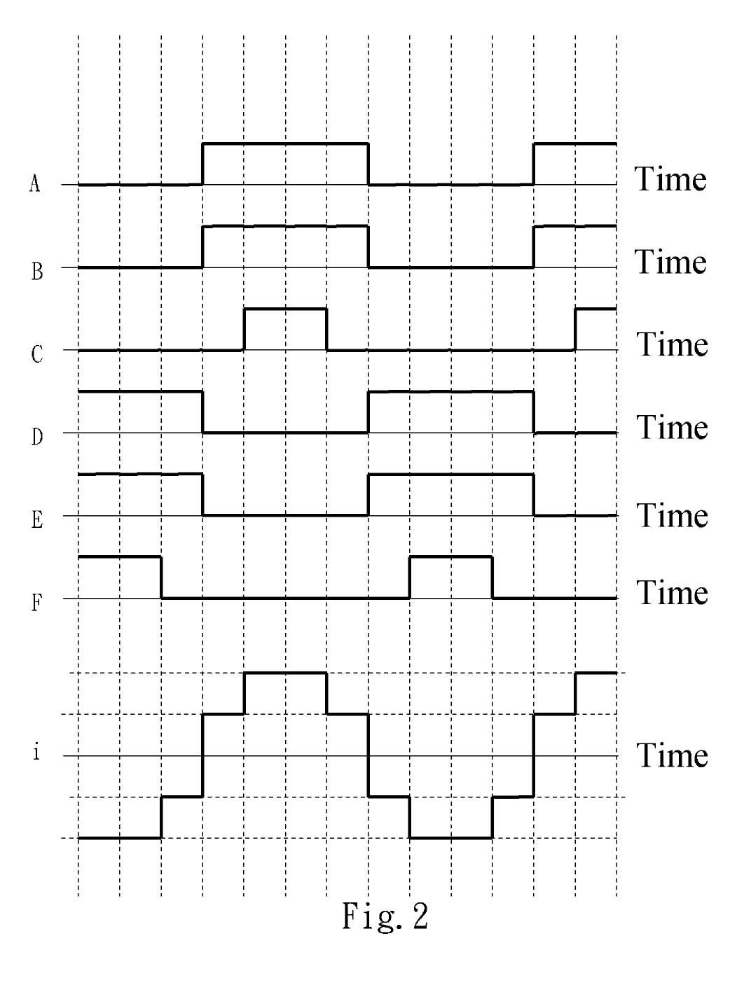

When one of the first and the second n-type MSFET E, B is turned on, the p-type MSFET A, D in one of the first and the second switch circuits C1, C2 that is not parallelly connected to the turned-on n-type MSFET E or B and the n-type MSFET F, C in one of the first and the second switch circuits C1, C2 that is parallelly connected to the turned-on n-type MSFET E or B are sequentially turned on to operate and thereby form the above-mentioned continuously changing drive currents, as shown in FIG. 2. And, the continuously changing drive currents are used to drive the fan L to operate. In the first preferred embodiment, two parallelly connected resistor elements R1, R2 are provided between the fan L and the first n-type MSFET E and between the fan L and the second n-type MSFET B, respectively.

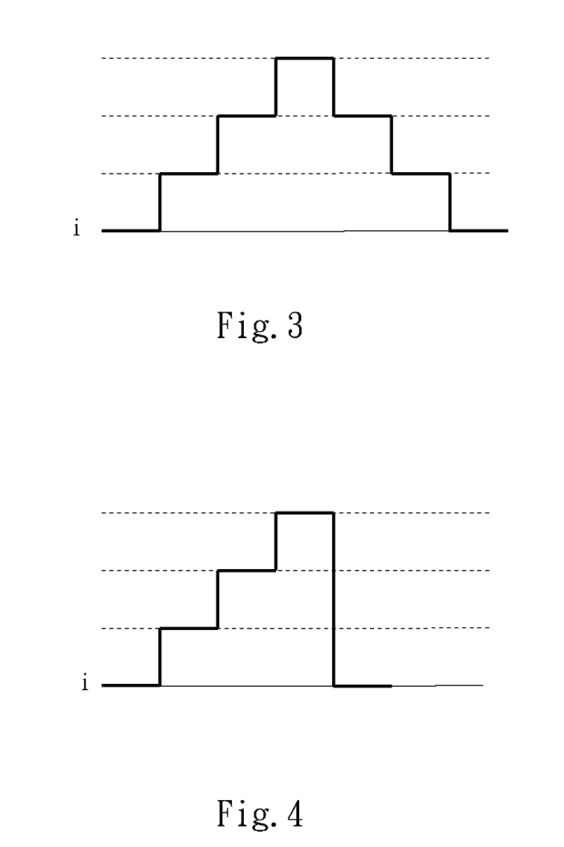

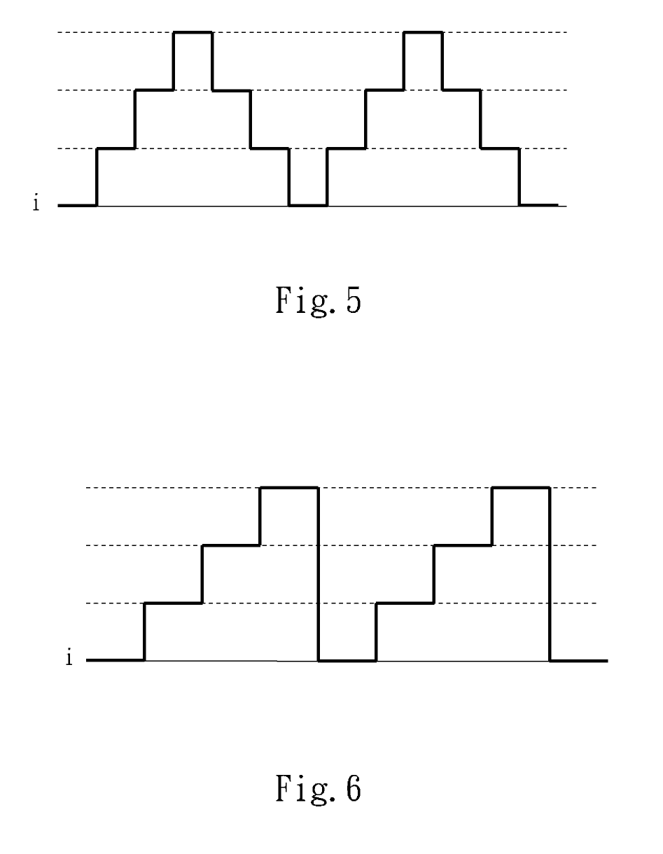

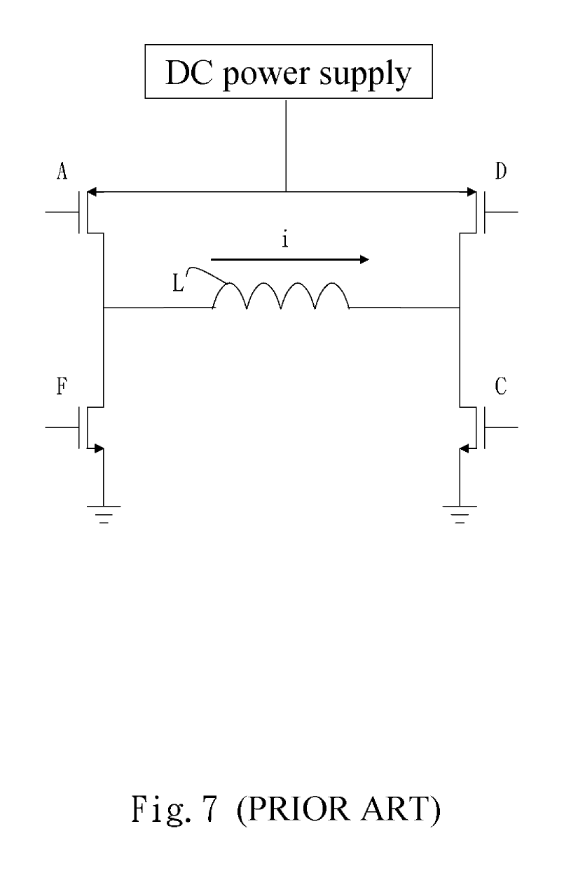

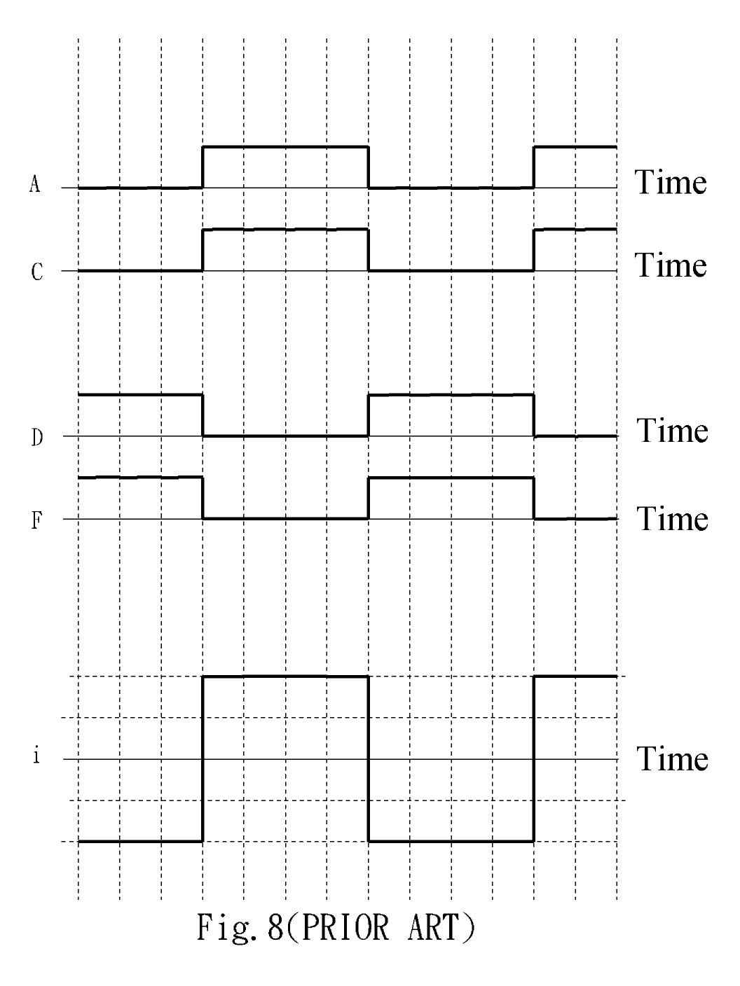

It should be noted the above described and illustrated embodiment is not intended to restrict the times and/or the magnitude of change in the above-mentioned continuously changing driven currents in order to achieve the largest drive current for the fan. For example, the continuously changing currents may change three times to achieve the largest fan drive current and have a single symmetrical waveform as shown in FIG. 3, or change three time to achieve the largest fan drive current and have a single asymmetrical waveform as shown in FIG. 4. When it is detected the vibration of fan has reached a certain undesirable degree, it is possible to drive the fan L to operate using the continuously changing drive currents, so as to inhibit the fan from vibrating. Alternatively, the continuously changing drive currents may be cycling signals to continuously inhibit the fan from vibrating, as shown in FIGS. 5 and 6.

In summary, the present invention uses a current buffer unit to divide an original drive current having a relatively large magnitude of change in current into multiple continuously changing drive currents that have relatively small magnitude of change in current, so that electric current supplied to the fan is regulated and output fractionally to not only reduce the fan vibration and associated noise caused by the large magnitude of change in current, but also enable the maintenance of a required heat dissipation effect at a step voltage having a relatively high voltage value. Therefore, the present invention provides the functions of dissipating heat and inhibiting vibration, and is very practical for use.

The present invention has been described with some preferred embodiments thereof and it is understood that many changes and modifications in the described embodiments can be carried out without departing from the scope and the spirit of the invention that is intended to be limited only by the appended claims.

What is claimed is:

1. Avibration-reduction fan driving circuit applicable to a fan operating according to a current signal sent thereto, comprising a current buffer unit connected to a drive current supplied from a power source and having a relatively large magnitude of change in current; the current buffer unit dividing the original drive current into multiple continuously changing drive currents that have a relatively small magnitude of change in current, so that electric current supplied to the fan is regulated and output fractionally to achieve the purpose of reducing the vibration of fan caused by a large magnitude of change in current.

2. The vibration-reduction fan driving circuit as claimed in claim 1, further comprising a first and a second switch circuit that are connected in parallel, each of the first and the second switch circuits including a p-type metal semiconductor field-effect transistor (MSFET) connected to a direct current (DC) power supply, and an n-type MSFET connected to a ground; a first node formed between the p-type MSFET and the n-type MSFET in the first switch circuit; and a second node formed between the p-type MSFET and the n-type MSFET in the second switch circuit; and the first and the second node serving as two inputs of the fan.

3. The vibration-reduction fan driving circuit as claimed in claim 2, wherein the current buffer unit includes a first n-type MSFET and a second n-type MSFET, which are parallelly connected to each other and separately provided at two ends of the fan; wherein the first n-type MSFET is located between the first node and the fan and is parallelly connected to the first switch circuit, and the second n-type MSFET is located between the second node and the fan, and is parallelly connected to the second switch circuit.

4. The vibration-reduction fan driving circuit as claimed in claim 3, further comprising two parallelly connected resistor elements, one of which is located between the first n-type MSFET and the fan, and the other one of which is located between the second n-type MSFET and the fan.

5. The vibration-reduction fan driving circuit as claimed in claim 3, wherein when the second n-type MSFET is on, the p-type MSFET in the first switch circuit and the n-type MSFET in the second switch circuit are sequentially turned on to operate to thereby form the multiple continuously changing drive currents that have relatively small magnitude of change in current.

6. The vibration-reduction fan driving circuit as claimed in claim 1, wherein the continuously changing drive currents have a symmetric waveform.

7. The vibration-reduction fan driving circuit as claimed in claim 1, wherein the continuously changing drive currents are cycling signals.
